(19) United States
(12) Patent Application Publication
(10) Pub. No.: US 2014/0074398 A1
(43) Pub. Date: Mar. 13, 2014

(54) POSITIONING UNIT, POSITIONING SYSTEM AND POSITIONING METHOD THEREOF

(71) Applicant: Accton Technology Corporation, Hsinchu City (TW)

(72) Inventors: I-Ru LIU, Taipei City (TW); Te-Yao LIU, Taipei City (TW)

(73) Assignee: Accton Technology Corporation, Hsinchu City (TW)

(21) Appl. No.: 13/952,769

(22) Filed: Jul. 29, 2013

(30) Foreign Application Priority Data
Sep. 7, 2012 (TW) 101132658

(51) Int. Cl. G01C 21/12

(52) U.S. Cl. CPC G01C 21/12
USPC 701/472

(57) ABSTRACT

A positioning unit, a positioning system and a positioning method thereof are provided. The positioning method is used in the positioning system and includes: receiving a plurality of global navigation satellite signals and generating a first satellite-positioning data by a first Global Navigation Satellite System (GNSS) radio unit; receiving the plurality of global navigation satellite signals and generating a second satellite-positioning data by a second Global Navigation Satellite System (GNSS) radio unit; receiving the first satellite-positioning data by a first GNSS unit; receiving the second satellite-positioning data by a second GNSS unit; and estimating a first positioning data and a second positioning data according to a measurement data of the vehicle, the first satellite-positioning data and the second satellite-positioning data by a dead-reckoning unit, the dead-reckoning unit outputs an output-positioning data correspondingly.

### CROSS REFERENCE TO RELATED APPLICATIONS

This application claims priority of Taiwan Patent Application No. 101132658, filed on Sep. 7, 2012, the entirety of which is incorporated by reference herein.

### BACKGROUND OF THE INVENTION

1. Field of the Invention

The invention relates to Global Navigation Satellite Systems (GNSS), and more particularly to GNSS combined with dead-reckoning system and Geographic Information System (GIS).

2. Description of the Related Art

GNSS is the standard generic term for satellite navigation systems that provides autonomous geospatial positioning with global coverage. GNSS is also known as Global Positioning System (GPS) in the United States. A GNSS receiver determines its location comprising longitudes, latitudes, and altitudes according to radio signals transmitted from satellites. A GNSS receiver also calculates the precise time. Thus, a device comprising a GNSS receiver can easily obtain precise positioning data. For example, a driver can easily lead his car to a destination according to the navigation instructions of a GNSS device.

However, a GNSS device also has its disadvantages. The quality of satellites communications may cause by many factors. For examples, amount of visible satellites determines the reception quality of GNSS signals. Furthermore, weather conditions and signal reception environments also greatly affect the quality of satellite communication, too. Since the GNSS receiver determines its location according to radio signals sent by satellites, the GNSS receiver cannot generate positioning data if satellite communication are failed. For example, when a car enters a tunnel, the receiving environment of the GNSS radio signals may be blocked accordingly, and the GNSS device in the car cannot generate positioning data according to the GNSS signals.

For determining a location of the GNSS device instead while the GNSS device is failed, a dead-reckoning device is introduced in the GNSS device to temporarily estimate the location. A dead-reckoning device estimates the location according its measurement thereof. The dead-reckoning device may be an accelerometer measuring acceleration, an odometer measuring distance traveled, or a gyro measuring angular rate (or a compass measuring absolute angles). The location estimation of a dead-reckoning device, however, produces greater deviations and can be used only for a short period.

To solve the problem, the invention provides a positioning system which comprises a first GNSS radio unit, a second GNSS radio unit, and a positioning unit, wherein the positioning unit comprises a first GNSS unit, a second GNSS unit, a dead-reckoning unit and a GIS unit. The positioning unit improves the precision of the positioning data generated by the first GNSS unit and the second GNSS unit. Thus, the positioning system provides location information with fewer errors and can be used longer as the GNSS system is failed.

### BRIEF SUMMARY OF THE INVENTION

A detailed description is given in the following embodiments with reference to the accompanying drawings.

A positioning unit, a positioning system and a positioning method thereof are provided.

In one exemplary embodiment, the disclosure is directed to a positioning unit. The positioning unit comprises a first Global Navigation Satellite System (GNSS) unit, a second Global Navigation Satellite System (GNSS) unit, and a dead-reckoning unit. The first GNSS unit is configured to receive a first satellite-positioning data. The second GNSS unit is configured to receive a second satellite-positioning data. The dead-reckoning unit is configured to estimate a first positioning data and a second positioning data according to a measurement data of the vehicle, the first satellite-positioning data and the second satellite-positioning data, and the dead-reckoning unit outputting an output-positioning data correspondingly.

In one exemplary embodiment, the disclosure is directed to a positioning system. The positioning system comprises a first Global Navigation Satellite System (GNSS) radio unit, a second Global Navigation Satellite System (GNSS) radio unit, and a positioning unit. The positioning unit is installed in a vehicle and comprises a first GNSS unit, a second GNSS unit and a dead-reckoning unit. The first GNSS radio unit is installed on the tunnel and is configured to receive a plurality of global navigation satellite signals and generate a first satellite-positioning data. The second GNSS radio unit is installed on the tunnel and is configured to receive the plurality of global navigation satellite signals and generate a second satellite-positioning data. The first GNSS unit is configured to receive the first satellite-positioning data. The second GNSS unit is configured to receive the second satellite-positioning data. The dead-reckoning unit is configured to estimate a first positioning data and a second positioning data according to a measurement data of the vehicle, the first satellite-positioning data and the second satellite-positioning data, and the dead-reckoning unit outputting an output-positioning data correspondingly.

In one exemplary embodiment, the disclosure is directed to a positioning method which is used in a positioning system. The method comprises following steps: receiving a plurality of global navigation satellite signals and generating a first satellite-positioning data by a first Global Navigation Satellite System (GNSS) radio unit; receiving the plurality of global navigation satellite signals and generating a second satellite-positioning data by a second Global Navigation Satellite System (GNSS) radio unit; and receiving the first satellite-positioning data by a first GNSS unit; receiving the second satellite-positioning data by a second GNSS unit; and estimating a first positioning data and a second positioning data according to a measurement data of the vehicle, the first satellite-positioning data and the second satellite-positioning data by a dead-reckoning unit, and the dead-reckoning unit outputting an output-positioning data correspondingly.

### BRIEF DESCRIPTION OF THE DRAWINGS

The invention can be more fully understood by reading the subsequent detailed description and examples with references made to the accompanying drawings, wherein:

FIG. 1 is a schematic diagram of a positioning system configuration according to an embodiment of the present invention;

FIG. 2 is a block diagram of a positioning unit according to an embodiment of the present invention;

FIG. 3 is a block diagram of a positioning unit according to another embodiment of the present invention;

FIGS. 4A˜4C are schematic diagrams for examining the positioning data according to an embodiment of the present invention;

FIGS. 4D˜4F are schematic diagrams for examining the positioning data according to an embodiment of the present invention;

FIG. 5 is a block diagram of a positioning unit according to another embodiment of the present invention;

FIG. 6 is a block diagram of a positioning unit according to another embodiment of the present invention; and

FIGS. 7A˜7B are flow diagrams illustrating a positioning method according to an embodiment of the present invention.

### DETAILED DESCRIPTION OF THE INVENTION

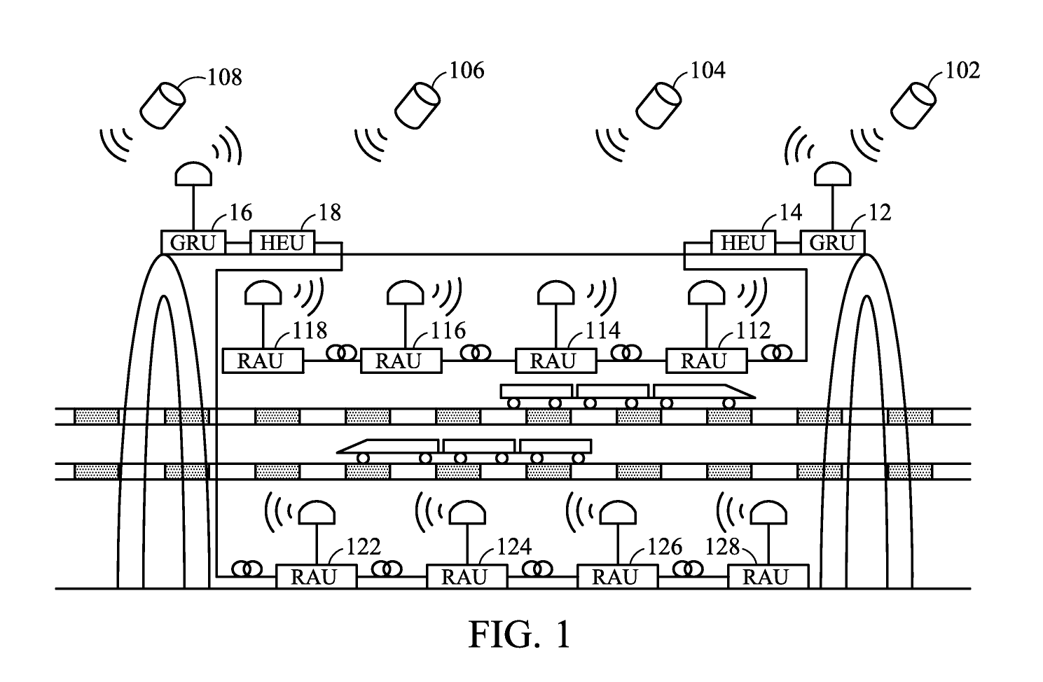

Several exemplary embodiments of the application are described with reference to FIGS. 1 through 6, which generally relate to a positioning unit, a positioning system and a positioning method thereof. It is understood that the following disclosure provides various different embodiments as examples for implementing different features of the application. Specific examples of components and arrangements are described in the following to simplify the present disclosure. These are, of course, merely examples and are not intended to be limited. In addition, the present disclosure may repeat reference numerals and/or letters in the various examples. This repetition is for the purpose of simplicity and clarity and does not in itself dictate a relationship between the various described embodiments and/or configurations.

FIG. 1 is a schematic diagram of a positioning system configuration according to an embodiment of the present invention. As shown in FIG. 1, a first Global Navigation Satellite System radio unit (GNSS Radio Unit, GRU) 12, a second GRU 16, a first head end unit (HEU) 14 and a second HEU 18 are installed on the outside of a tunnel entrance and a tunnel exit respectively. The first HEU 14 and the first GRU 12 are coupled to each other and installed on the outside of the tunnel entrance, and the first HEU 14 is further coupled to Remote Antenna Units (RAU) 112, 114, 116 and 118 which installed inside the tunnel. The second HEU 18 and the second GRU 16 are coupled to each other and installed on the outside of the tunnel exit, and the second HEU 18 is further coupled to RAUs 122, 124, 126 and 128 which installed inside the tunnel. The first GRU 12 receives a plurality of global navigation satellite signals generated by a plurality of Global Navigation Satellite Systems (GNSS) 102, 104, 106 and 108, transfers the plurality of global navigation satellite signals into optical signals by the first HEU 14 and transmits the optical signals to remote antennas 112, 114, 116 and 118 inside the tunnel. After receiving the signals transmitted by the first HEU 14, the remote antennas 112, 114, 116 and 118 inside the tunnel transmit the signals to vehicles and trains traveling in the tunnel. Similarly, when receiving the plurality of global navigation satellite signals generated by the plurality of Global Navigation Satellite Systems (GNSS) 102, 104, 106 and 108, the second GRU 16 transfers the plurality of global navigation satellite signals to the optical signals by the second HEU 18 and transmits the remote antennas 122, 124, 126 and 128 inside the tunnel. After receiving the signals transmitted from the second HEU 18, the remote antennas 112, 114, 116 and 118 installed inside the tunnel transmits the signals to the vehicles and trains traveling in the tunnel. Then, a positioning unit installed in the vehicles and trains (not shown in FIG. 1) can determine the position of the vehicles and trains according to the signals transmitted from the remote antennas 112, 114, 116 and 118.

In other embodiments, the GRUs and the HEUs can also be installed in other positions of the tunnel, e.g. the middle of the tunnel or other positions, and amount of the GRUs and the HEUs may be increased or decreased and not be limited to two.

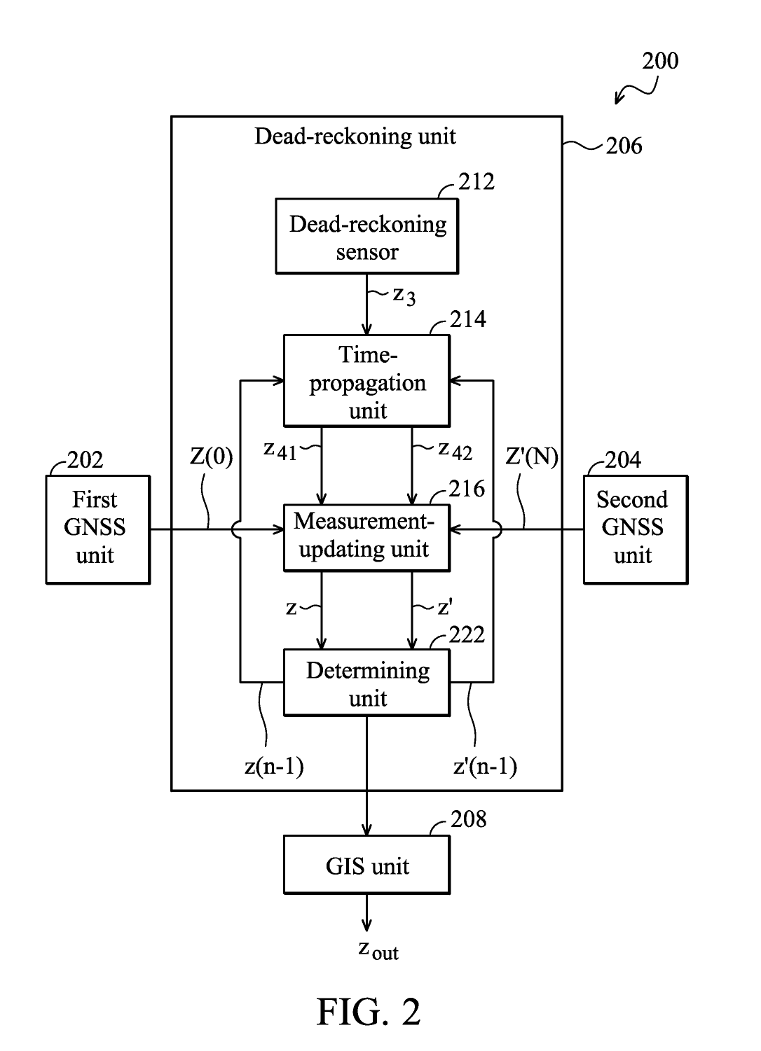

FIG. 2 is a block diagram of a positioning unit 200 according to an embodiment of the present invention with reference to FIG. 1. The positioning unit 200 is installed in a vehicle and comprises a first GNSS unit 202, a second GNSS unit 204, a dead-reckoning unit 206 and a Geographic Information System (GIS) unit 208. The first GNSS unit 202 and the second GNSS unit 204 are configured to receive a first satellite-positioning data Z(0) and a second satellite-positioning data Z′(n) transmitted from the first GRU 12 and the second GRU 16 respectively. In one embodiment, the first satellite-positioning data Z(0) and the second satellite-positioning data Z′(n) include a position data, a velocity data, and a time data.

The dead-reckoning unit 206 comprises a dead-reckoning sensor 212, a time-propagation unit 214, a measurement-updating unit 216 and a determining unit 222. The dead-reckoning sensor 212 detects movement of the vehicle and generates a measurement data of the positioning unit 200. In one embodiment, the dead-reckoning sensor 212 is a linear movement sensor measuring a linear movement of the vehicle to generate the movement data, such as an accelerometer measuring acceleration or an odometer measuring distance travelled. In another embodiment, the dead-reckoning sensor 212 is an angular movement sensor measuring an angular movement of the vehicle to generate the movement data, such as a gyro measuring angular displacement or a compass measuring absolute angles. In a further embodiment, the dead-reckoning sensor 212 is the integration of at least a linear movement sensor and an angular movement sensor.

After detecting the measurement data of the vehicle by the dead-reckoning sensor 212, the dead-reckoning unit 206 generates a positioning data z and a positioning data z′ according to the first satellite-positioning data Z(0) and the second satellite-positioning data Z′ (n) respectively. Phases (1) and (2) below will describe how the dead-reckoning unit 206 generate the positioning data z(n) and the positioning data z′(n):

(1) when the measurement-updating unit 216 of the dead-reckoning unit 206 receives the first satellite-positioning data Z(0) transmitted from the first GNSS unit 202, the time-propagation unit 214 estimates a navigation data z₄₁(n) at a certain point in time n according to a feedback-positioning data z(n−1) at a previous point in time n−1 and the measurement data z₃(n) at the certain point in time n generated by the dead-reckoning sensor 212. Then, the measurement-updating unit 216 estimates the positioning data z(n) at the certain point in time n according to the navigation data z₄₁(n) at the certain point in time n and the first satellite-positioning data Z(0). The new positioning data z(n) can be calculated as follows:

z(n)=z(n−1)+(τ/2)[ν(n)+ν(n−1)],

z(n)=z(n−1)+(τ/2){2ν(n−1)+(τ/2)[a(n)+a(n−1)]}, or

z(n)=z(n−1)+(τ/2){2ν(n)+(τ/2)[a(n)+a(n−1)]},

wherein τ is the time difference of arrival (TDOA), and a and ν are the acceleration and speed of the vehicle respectively.

(2) Similarly, when the measurement-updating unit 216 of the dead-reckoning unit 206 receives the second satellite-positioning data Z′ (N) transmitted from the second GNSS unit 204, the time-propagation unit 214 estimates a navigation data z₄₂(n) at the certain point in time n according to a feedback-positioning data z′(n−1) at the previous point in time n−1 and the measurement data z₃(n) at the certain point in time n generated by the dead-reckoning sensor 212. Then, the measurement-updating unit 216 estimates the positioning data z′(n) at the certain point in time n according to the navigation data z₄₂(n) at the certain point in time n and the second satellite-positioning data Z′(N). The new positioning data z′(n) can be calculated as follows:

z′(n)=z′(n−1)+(τ/2)[ν(n)+ν(n−1)],

z′(n)=z′(n−1)+(τ/2){2ν(n−1)+(τ/2)[a(n)+a(n−1)]}, or

z′(n)=z′(n−1)+(τ/2){2ν(n)+(τ/2)[a(n)+a(n−1)]},

wherein τ is the time difference of arrival (TDOA), and a and ν are acceleration and speed of the vehicle respectively.

Next, the determining unit 222 determines the positioning data which is output to the GIS unit 208 from the positioning data z and the positioning data z′ according to a predetermined priority. Then, the positioning data z and the positioning data z′ are fed back to the dead-reckoning unit 206. After receiving the positioning data transmitted from the dead-reckoning unit 206, the GIS unit 208 fits the positioning data transmitted from the dead-reckoning unit 206 to a map stored in the GIS unit 208 as a final output zₒᵤₜ of the positioning unit 200. The positioning data z and the positioning data z′ are fed back to the time-propagation unit 214 of the dead-reckoning unit 206 for estimating the positioning data of the next time point.

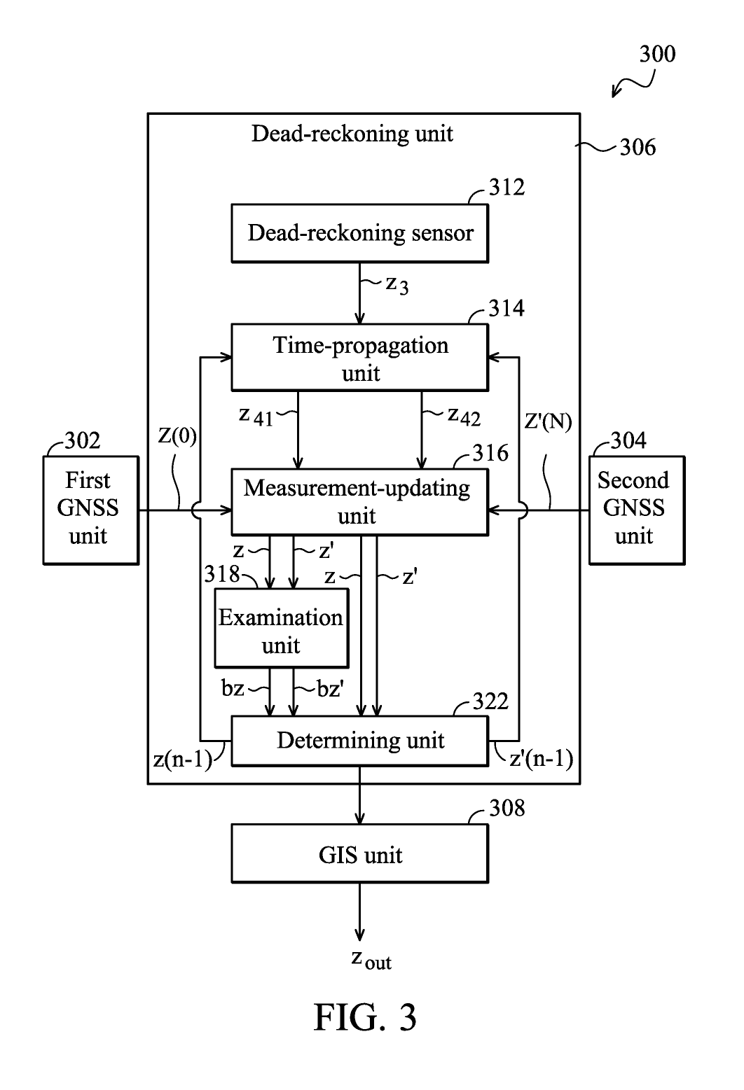

FIG. 3 is a block diagram of a positioning unit 300 according to another embodiment of the present invention with reference to FIG. 1. Similar to the positioning unit 200, the positioning unit 300 comprises a first GNSS unit 302, a second GNSS unit 304, a dead-reckoning unit 306 and a GIS unit 308. The first GNSS unit 302 and the second GNSS unit 304 are similar to the first GNSS unit 202 and the second GNSS unit 204 of FIG. 2, configured to receive the first satellite-positioning data Z(0) and the second satellite-positioning data Z′ (n) transmitted from the first GRU 12 and the second GRU 16 respectively. The dead-reckoning unit 306 is similar to the dead-reckoning unit 206 of FIG. 2, configured to generate a positioning data.

Difference between the positioning unit 200 in previous embodiment and the positioning unit 300 in current embodiment is the dead-reckoning unit 306 in current embodiment comprises a dead-reckoning sensor 312, a time-propagation unit 314, a measurement-updating unit 316, an examination unit 318, and a determining unit 322.

After detecting the measurement data of the vehicle by the dead-reckoning sensor 312, the dead-reckoning unit 306 generates a positioning data z and a positioning data z′ according to the first satellite-positioning data Z(0) and the second satellite-positioning data Z′(n). As shown in FIG. 3, the detailed procedure which the dead-reckoning sensor 312, the time-propagation unit 314 and the measurement-updating unit 316 generate the positioning data z(n) and the positioning data z′(n) according to the first satellite-positioning data Z(0) and the second satellite-positioning data Z′ (n) is similar to the procedure mentioned in FIG. 2. Therefore, a detailed description of the process is omitted here for brevity.

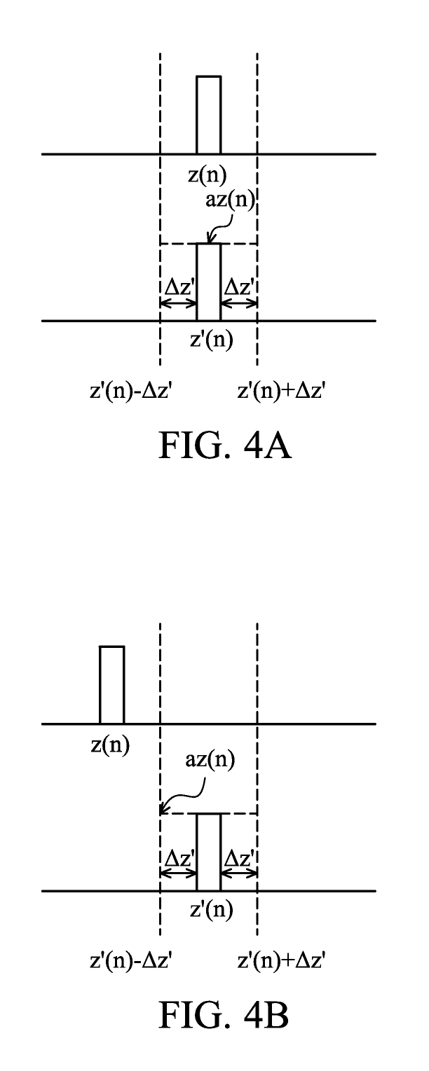

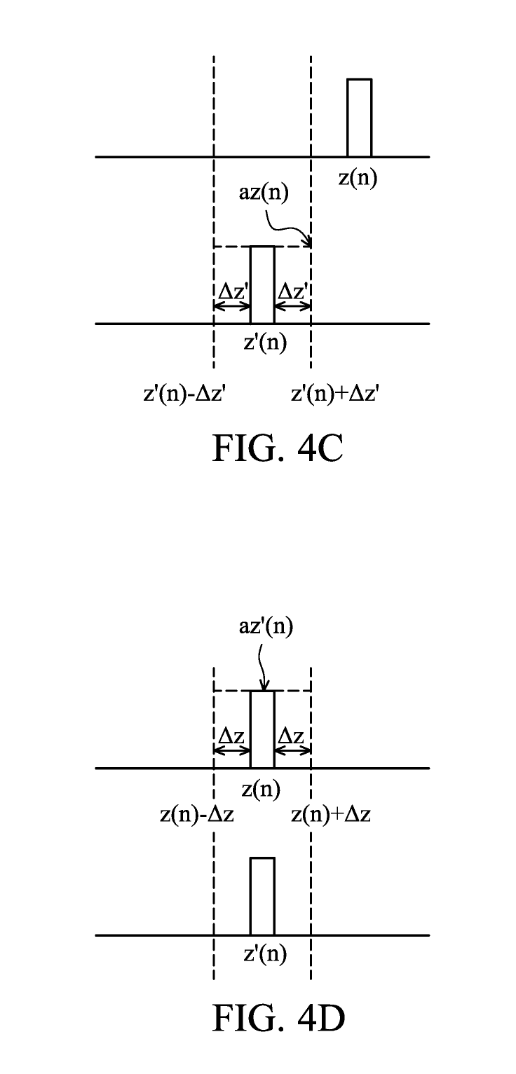

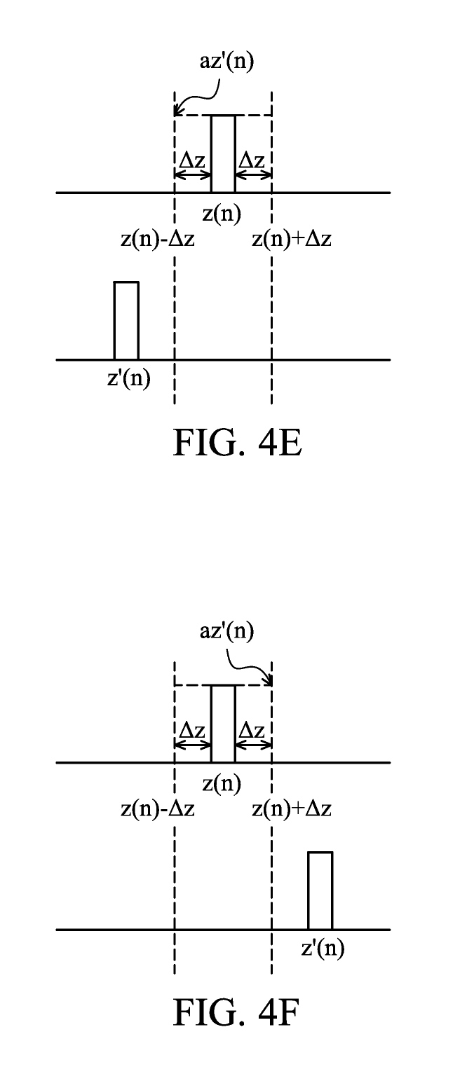

In the embodiment, the examination unit 318 can examine the positioning data z(n) and the positioning data z′(n) according to a predetermined variation to generate new positioning data az(n) and az′(n) respectively. Phases (3) and (4) below and FIGS. 4A˜4F will describe how the examination unit 318 examines the positioning data z(n) and z′(n) and generates the new positioning data az(n) and az′(n):

(3) FIGS. 4A˜4C are schematic diagrams for examining the positioning data according to an embodiment of the present invention. Before examining the positioning data z(n), the examination unit 318 can define a first examination window with a range from z′(n)−Δz′ to z′ (n)+Δz′ according to a predetermined variation Δz′ (the range indicated by the dashed line in FIGS. 4A˜4C) to examine the positioning data z(n). In one embodiment, when z(n) is in the first examination window, (as shown in FIG. 4A, it means that z(n) is greater than or equal to z′(n)−Δz′ and smaller than or equal to z′(n)+Δz′), the examination unit 318 defines the positioning data z(n) as a new positioning data az(n). When z(n) is out of the first examination window and is smaller than the first examination window, (as shown in FIG. 4B, it means that z(n) is smaller than z′(n)−Δz′), the examination unit 318 defines the positioning data z′(n)−Δz′ as the new positioning data az(n). When z(n) is out of the first examination window and is greater than the first examination window, (as shown in FIG. 4C, it means that z(n) is greater than z′(n)+Δz′), the examination unit 318 defines the positioning data z′(n)+Δz′ as the new positioning data az(n).

(4) FIGS. 4D˜4F are schematic diagrams for examining the positioning data according to an embodiment of the present invention. Similarly, before examining the positioning data z′(n), the examination unit 318 can define a second examination window with a range from z(n)−Δz to z(n)+Δz according to a predetermined variation Δz (the range indicated by the dashed line in FIGS. 4D˜4F) to examine the positioning data z(n). In one embodiment, when z′(n) is in the second examination window, (as shown in FIG. 4D, it means that z′(n) is greater than or equal to z(n)−Δz and smaller than or equal to z(n)+Δz), the examination unit 318 defines the positioning data z′(n) as a new positioning data az′(n). When z′(n) is out of the second examination window and is smaller than the second examination window, (as shown in FIG. 4E, it means that z′(n) is smaller than z(n)−Δz), the examination unit 318 defines the positioning data z(n)−Δz as the new positioning data az′(n). When z(n) is out of the second examination window and is greater than the second examination window, (as shown in FIG. 4F, it means that z(n) is greater than z(n)+Δz), the examination unit 318 defines the positioning data z(n)+Δz as the new positioning data az′(n).

After examining and generating the new positioning data az(n) and az′(n) according to the predetermined variation, the examination unit 318 transmits the new positioning data az(n) and az′(n) to the determining unit 322. Next, the determining unit 322 determines the positioning data which is output to the GIS unit 308 from the positioning data z, z′, az(n) and az′(n) according to a predetermined priority. Then, the positioning data z and the positioning data z′ are fed back to the time-propagation unit 314 of the dead-reckoning unit 306 for estimating the positioning data of the next time point.

Finally, the GIS unit 308 fits the positioning data transmitted from the determining unit 322 to a map stored in the GIS unit 308 as a final output zₒᵤₜ of the positioning unit 300.

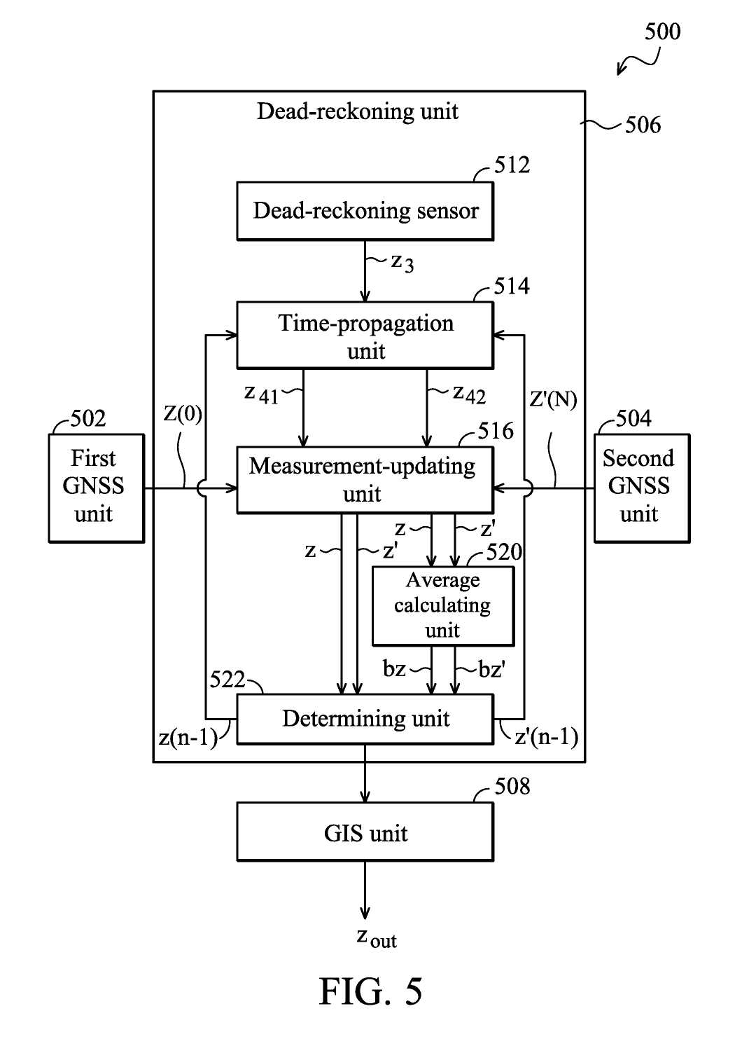

FIG. 5 is a block diagram of a positioning unit 500 according to another embodiment of the present invention with reference to FIG. 1. Similar to the positioning unit 200, the positioning unit 500 comprises a first GNSS unit 502, a second GNSS unit 504, a dead-reckoning unit 506 and a GIS unit 508. The first GNSS unit 502 and the second GNSS unit 504 are the same as the first GNSS unit 202 and the second GNSS unit 204 of FIG. 2, configured to receive the first satellite-positioning data Z(0) and the second satellite-positioning data Z′(n) transmitted from the first GRU 12 and the second GRU 16, respectively. The dead-reckoning unit 506 is similar to the dead-reckoning unit 206 of FIG. 2, configured to generate a positioning data.

Difference between the positioning unit 200 in previous embodiment and the positioning unit 500 in current embodiment is the dead-reckoning unit 506 comprises a dead-reckoning sensor 512, a time-propagation unit 514, a measurement-updating unit 516, and an average calculating unit 520 and a determining unit 522.

After detecting the measurement data of the vehicle by the dead-reckoning sensor 512, the dead-reckoning unit 506 generates a positioning data z and a positioning data z′ according to the first satellite-positioning data Z(0) and the second satellite-positioning data Z′(n). As shown in FIG. 5, the detailed procedure which the dead-reckoning sensor 512, the time-propagation unit 514 and the measurement-updating unit 516 generate the positioning data z(n) and the positioning data z′(n) according to the first satellite-positioning data Z(0) and the second satellite-positioning data Z′(n) is the same as the procedure mentioned in FIG. 2. Therefore, the procedure need not be repeated here in elaborate detail.

In the embodiment, the average calculating unit 520 can adjust the weights of the positioning data z(n) and the positioning data z′(n) according to a first predetermined weight and a second predetermined weight to generate new positioning data bz(n) and bz′(n). Phases (5) and (6) below will describe how the average calculating unit 520 generates the new positioning data bz(n) and bz′(n):

(5) when a user considers that the positioning data z(n) is more important, the user can predetermine a first predetermined weight % Δz′. The average calculating unit 520 adjusts the weights of the positioning data z(n) and z′(n) according to the first predetermined weight % Δz′, and generates the new positioning data bz(n). The new positioning data bz(n) can be calculated as follows:

bz(n)=(1−%Δz′)z(n)+(%Δz′)z′(n),

wherein the first predetermined weight % Δz′ is a value which is smaller than or equal to 0.5.

(6) Similarly, when a user considers that the positioning data z′(n) is more important, the user can predetermine a second predetermined weight % Δz′. The average calculating unit 520 adjusts the weights of the positioning data z(n) and z′(n) according to the second predetermined weight % Δz′, and generates the new positioning data bz′(n). The new positioning data bz′(n) can be calculated as follows:

bz(n)=(%Δz)z(n)+(1−%Δz)z′(n),

wherein the second predetermined weight % Δz is a value which is smaller than or equal to 0.5.

After adjusting and generating the new positioning data bz(n) and bz′(n) according to the first predetermined weight % Δz′ the second predetermined weight % Δz, the average calculating unit 520 transmits the new positioning data bz(n) and bz′(n) to the determining unit 522. Next, the determining unit 522 determines the positioning data which is output to the GIS unit 508 from the positioning data z, z′, bz(n) and bz′(n) according to a predetermined priority. Then, the positioning data z and the positioning data z′ are fed back to the time-propagation unit 514 of the dead-reckoning unit 506 for estimating the positioning data of the next time point.

Finally, the GIS unit 508 fits the positioning data transmitted from the determining unit 522 to a map stored in the GIS unit 508 as a final output zₒᵤₜ of the positioning unit 500.

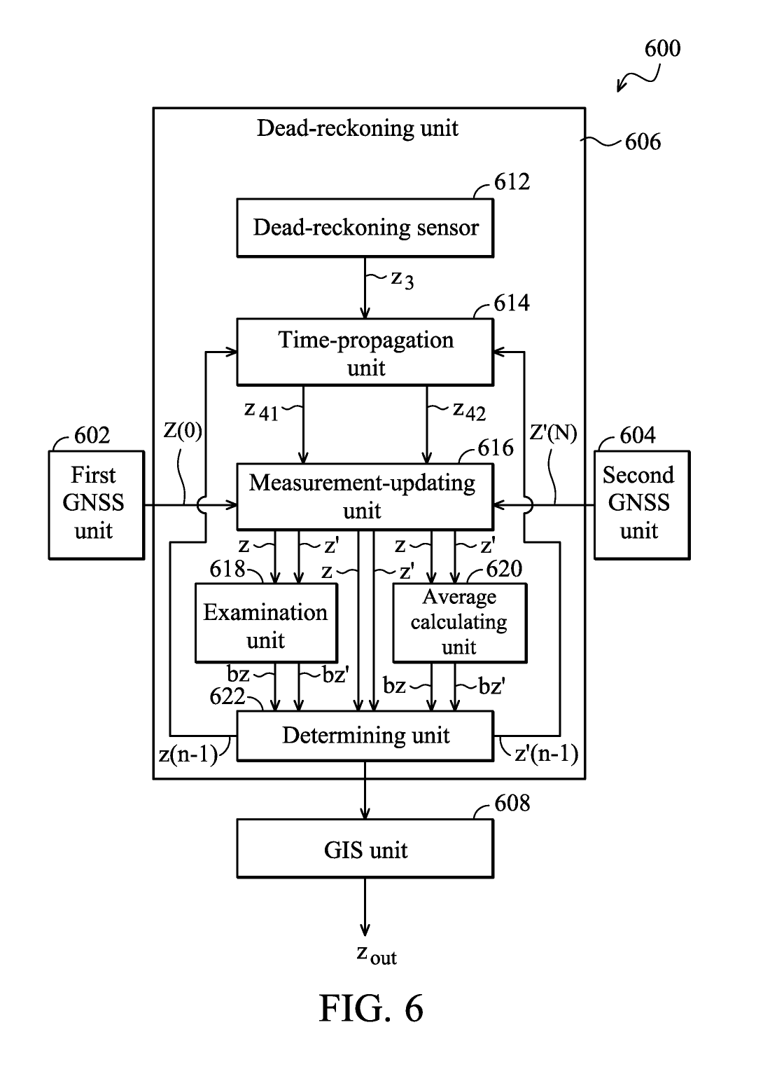

It is worth noting that the average calculating unit and the examination unit described above can be integrated into the dead-reckoning unit to simplify the positioning unit, such as shown in FIG. 6. FIG. 6 is a block diagram of a positioning unit 600 according to another embodiment of the present invention. The positioning unit 600 comprises a first GNSS unit 602, a second GNSS unit 604, a dead-reckoning unit 606 and a GIS unit 608. The dead-reckoning unit 606 comprises a dead-reckoning sensor 612, a time-propagation unit 614, a measurement-updating unit 616, and an average calculating unit 620 and a determining unit 622. The components having the same name as described in the embodiments described above have the same function. In the embodiment, the dead-reckoning unit 606 may generate the positioning data z, z′, az(n), az′(n), bz(n) and bz′(n) at the same time. The determining unit 622 can determine the positioning data which is output to the GIS unit 608 from the positioning data z, z′, az(n), az′(n), bz(n) and bz′(n) according to a predetermined priority. Then, after receiving the positioning data output from the determining unit 622, the GIS unit 608 fits the positioning data to a map stored in the GIS unit 608 as a final output zₒᵤₜ of the positioning unit 600.

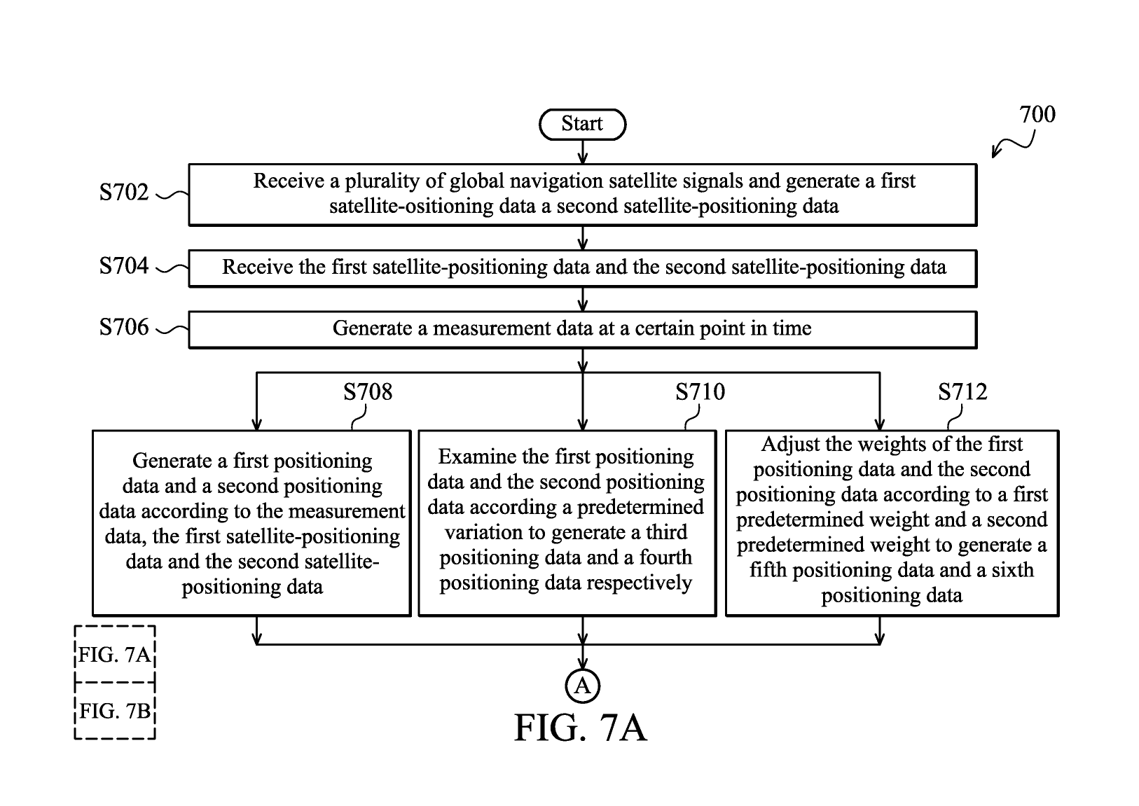

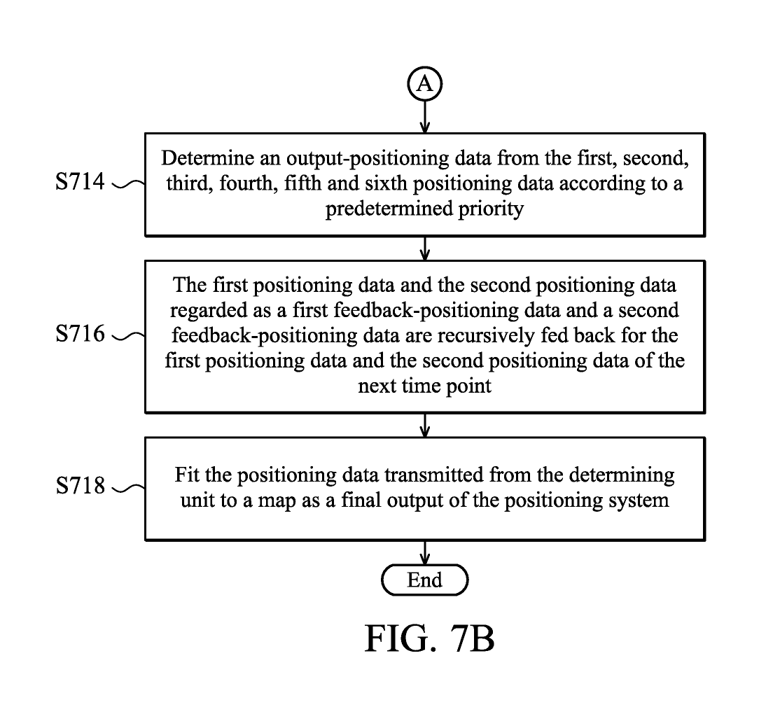

FIGS. 7A˜7B are flow diagrams illustrating a positioning method 700 according to an embodiment of the present invention. The positioning method is used in the positioning system of FIG. 1. The positioning unit 600 of FIG. 6 is used in the vehicle of the positioning system.

First, in step S702, a first GNSS radio unit receives a plurality of global navigation satellite signals and generates a first satellite-positioning data, and a second GNSS radio unit receives the plurality of global navigation satellite signals and generates a second satellite-positioning data. In step S704, a first GNSS unit and a second GNSS unit receive the first satellite-positioning data and the second satellite-positioning data respectively. In step S706, a dead-reckoning sensor generates a measurement data at a certain point in time. In step S708, a dead-reckoning unit generates a first positioning data and a second positioning data according to the measurement data, the first satellite-positioning data and the second satellite-positioning data. In step S710, an examination unit examines the first positioning data and the second positioning data according a predetermined variation to generate a third positioning data and a fourth positioning data respectively. In step S712, an average calculating unit adjusts the weights of the first positioning data and the second positioning data according to a first predetermined weight and a second predetermined weight to generate a fifth positioning data and a sixth positioning data. In step S714, a determining unit determines an output-positioning data from the first, second, third, fourth, fifth and sixth positioning data according to a predetermined priority. In step S716, the first positioning data and the second positioning data regarded as a first feedback-positioning data and a second feedback-positioning data are recursively fed back for the first positioning data and the second positioning data of the next time point. Finally, in step S718, the GIS unit fits the positioning data transmitted from the determining unit to a map as a final output of the positioning system.

The invention provides a positioning system comprising a first GNSS radio unit, a second GNSS radio unit, and a positioning unit, wherein the positioning unit comprises a first GNSS unit, a second GNSS unit, a dead-reckoning unit and a GIS unit. The satellite-positioning data transmitted from the first GNSS unit and the second GNSS unit and the navigation data generated by the dead-reckoning unit are combined to generate the output-positioning data. In addition, the GIS unit fits the output-positioning data to a map to generate a final positioning data with higher precision. In the positioning system of the present invention, the positioning data generated by using two GNSS radio units and the measurement data can be examined by using a predetermined variation, or can be adjusted by using predetermined weights to make the final positioning data more accurate.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A positioning unit, installed in a vehicle, comprising:
a first Global Navigation Satellite System (GNSS) unit, configured to receive a first satellite-positioning data;
a second Global Navigation Satellite System (GNSS) unit, configured to receive a second satellite-positioning data; and
a dead-reckoning unit, configured to estimate a first positioning data and a second positioning data according to a measurement data of the vehicle, the first satellite-positioning data and the second satellite-positioning data, and the dead-reckoning unit outputting an output-positioning data correspondingly.

2. The positioning unit as claimed in claim 1, wherein the dead-reckoning unit further comprises:
a dead-reckoning sensor, configured to generate the measurement data at a certain point in time;
a time-propagation unit, configured to estimate a first navigation data and a second navigation data at the certain point in time according to a first feedback-positioning data, a second feedback-positioning data of a previous point in time, and the measurement data of the certain point in time; and
a measurement-updating unit, configured to estimate the first satellite-positioning data and the second satellite-positioning data at the certain point in time according to the first navigation data, the second navigation data at the certain point in time and the first satellite-positioning data and the second satellite-positioning data.

3. The positioning unit as claimed in claim 2, wherein
the measurement-updating unit estimates the first positioning data at the certain point in time according to the first navigation data and the first satellite-positioning at the certain point in time as the measurement-updating unit receives the first satellite-positioning data at the certain point in time; or
the measurement-updating unit estimates the second positioning data at the certain point in time according to the second navigation data at the certain point in time and the second satellite-positioning data at the certain point in time as the measurement-updating unit receives the second satellite-positioning data at the certain point in time.

4. The positioning unit as claimed in claim 2, wherein the dead-reckoning unit further comprises:
an examination unit, configured to define a first examination window and a second examination window according to a predetermined variation, the first positioning data and the second positioning data respectively, and configured to examine the first positioning data and the second positioning data according to the first examination window and a second examination window to generate a third positioning data and the fourth positioning data respectively.

5. The positioning unit as claimed in claim 4, wherein
the examination unit defines the first positioning data as the third positioning data when the first positioning data is in the first examination window;
the examination unit defines the minimum of the first examination window as the third positioning data when the first positioning data is out of the first examination window and is smaller than the first examination window;
the examination unit defines the maximum of the first examination window as the third positioning data when the first positioning data is out of the first examination window and is greater than the first examination window;
the examination unit defines the second positioning data as the fourth positioning data when the second positioning data is in the second examination window;
the examination unit defines the minimum of the second examination window as the fourth positioning data when the second positioning data is out of the second examination window and is smaller than the second examination window; or
the examination unit defines the maximum of the second examination window as the fourth positioning data when the second positioning data is out of the second examination window and is greater than the second examination window.

6. The positioning unit as claimed in claim 2, wherein the dead-reckoning unit further comprises:
an average calculating unit, configured to generate a fifth positioning data and a sixth positioning data according to a first predetermined weight, a second predetermined weight, the first positioning data and the second positioning data.

7. The positioning unit as claimed in claim 6, wherein
the average calculating unit generates the fifth positioning data according to the following formula:
the fifth positioning data=the first predetermined weight*the first positioning data+the second predetermined weight*the second positioning data, wherein the first predetermined weight=(1−%Δz′), the second predetermined weight=%Δz′, and %Δz′≦0.5; or
the average calculating unit generates the sixth positioning data according to the following formula:
the sixth positioning data=the first predetermined weight*the first positioning data+the second predetermined weight*the second positioning data, wherein the first predetermined weight=%Δz′, the second predetermined weight=(1−%Δz′), and %Δz′≦0.5.

8. A positioning system, used in a tunnel, comprising:
a first Global Navigation Satellite System (GNSS) radio unit, installed on the tunnel and configured to receive a plurality of global navigation satellite signals and generate a first satellite-positioning data;
a second Global Navigation Satellite System (GNSS) radio unit, installed on the tunnel and configured to receive the plurality of global navigation satellite signals and generate a second satellite-positioning data; and
a positioning unit, installed in a vehicle, comprising:
a first GNSS unit, configured to receive the first satellite-positioning data;
a second GNSS unit, configured to receive the second satellite-positioning data; and
a dead-reckoning unit, configured to estimate a first positioning data and a second positioning data according to a measurement data of the vehicle, the first satellite-positioning data and the second satellite-positioning data, and the dead-reckoning unit outputting an output-positioning data correspondingly.

9. The positioning system as claimed in claim 8, wherein the dead-reckoning unit further comprises:
a dead-reckoning sensor, configured to generate the measurement data at a certain point in time;
a time-propagation unit, configured to estimate a first navigation data and a second navigation data at the certain point in time according to a first feedback-positioning data, a second feedback-positioning data at a previous point in time and the measurement data at the certain point in time; and
a measurement-updating unit, configured to estimate the first satellite-positioning data and the second satellite-positioning data at the certain point in time according to the first navigation data, the second navigation data at the certain point in time and the first satellite-positioning data and the second satellite-positioning data.

10. The positioning system as claimed in claim 9, wherein
the measurement-updating unit estimates the first positioning data at the certain point in time according to the first navigation data at the certain point in time and the first satellite-positioning data at the certain point in time as the measurement-updating unit receives the first satellite-positioning data at the certain point in time; or
the measurement-updating unit estimates the second positioning data at the certain point in time according to the second navigation data at the certain point in time and the second satellite-positioning data at the certain point in time as the measurement-updating unit receives the second satellite-positioning data at the certain point in time.

11. The positioning system as claimed in claim 9, wherein the dead-reckoning unit further comprises:
an examination unit, configured to define a first examination window and a second examination window according to a predetermined variation, the first positioning data and the second positioning data respectively, and configured to examine the first positioning data and the second positioning data to generate a third positioning data and a fourth positioning data according to the first examination window and a second examination window respectively.

12. The positioning system as claimed in claim 11, wherein:
the examination unit defines the first positioning data as the third positioning data when the first positioning data is in the first examination window;
the examination unit defines the minimum of the first examination window as the third positioning data when the first positioning data is out of the first examination window and is smaller than the first examination window;
the examination unit defines the maximum of the first examination window as the third positioning data when the first positioning data is out of the first examination window and is greater than the first examination window;
the examination unit defines the second positioning data as the fourth positioning data when the second positioning data is in the second examination window;
the examination unit defines the minimum of the second examination window as the fourth positioning data when the second positioning data is out of the second examination window and is smaller than the second examination window; or
the examination unit defines the minimum of the second examination window as the fourth positioning data when the second positioning data is out of the second examination window and is greater than the second examination window.

13. The positioning system as claimed in claim 9, wherein the dead-reckoning unit further comprises:
an average calculating unit, configured to generate a fifth positioning data and a sixth positioning data according to a first predetermined weight, a second predetermined weight, the first positioning data and the second positioning data.

14. The positioning system as claimed in claim 13, wherein
the average calculating unit generates the fifth positioning data according to the following formula:
the fifth positioning data=the first predetermined weight*the first positioning data+the second predetermined weight*the second positioning data, wherein the first predetermined weight=(1−%Δz′), the second predetermined weight=%Δz′, and %Δz′≦0.5; or
the average calculating unit generates the sixth positioning data according to the following formula:
the sixth positioning data=the first predetermined weight*the first positioning data+the second predetermined weight*the second positioning data, wherein the first predetermined weight=%Δz′, the second predetermined weight=(1−%Δz′), and %Δz′≦0.5.

15. A positioning method, used in a positioning system, comprising following steps:
receiving a plurality of global navigation satellite signals and generating a first satellite-positioning data by a first Global Navigation Satellite System (GNSS) radio unit;
receiving the plurality of global navigation satellite signals and generating a second satellite-positioning data by a second Global Navigation Satellite System (GNSS) radio unit;
receiving the first satellite-positioning data by a first GNSS unit;
receiving the second satellite-positioning data by a second GNSS unit; and
estimating a first positioning data and a second positioning data according to a measurement data of the vehicle, the first satellite-positioning data and the second satellite-positioning data by a dead-reckoning unit, and the dead-reckoning unit outputting an output-positioning data correspondingly.

16. The positioning method as claimed in claim 15 further comprising following steps:
generating the measurement data at a certain point in time by a dead-reckoning sensor;
estimating a first navigation data and a second navigation data at the certain point in time according to a first feedback-positioning data, a second feedback-positioning data at a previous point in time and the measurement data at the certain point in time by a time-propagation unit; and
estimating the first satellite-positioning data and the second satellite-positioning data at the certain point in time according to the first navigation data, the second navigation data at the certain point in time, the first satellite-positioning data and the second satellite-positioning data by a measurement-updating unit.

17. The positioning method as claimed in claim 16, further comprising following steps:
defining a first examination window and a second examination window according to a predetermined variation and the first positioning data and the second positioning data by an examination unit respectively; and
examining the first positioning data and the second positioning data to generate a third positioning data and a fourth positioning data by using the first examination window and a second examination window by the examination unit respectively.

18. The positioning method as claimed in claim 17 further comprising following steps:
defining the first positioning data as the third positioning data by the examination unit when the first positioning data is in the first examination window;
defining the minimum of the first examination window as the third positioning data by the examination unit when the first positioning data is out of the first examination window and is smaller than the first examination window;
defining the maximum of the first examination window as the third positioning data by the examination unit when the first positioning data is out of the first examination window and is greater than the first examination window;
defining the second positioning data as the fourth positioning data by the examination unit when the second positioning data is in the second examination window;
defining the minimum of the second examination window as the fourth positioning data by the examination unit when the second positioning data is out of the second examination window and is smaller than the second examination window; or
defining the maximum of the second examination window as the fourth positioning data by the examination unit when the second positioning data is out of the second examination window and is greater than the second examination window.

19. The positioning method as claimed in claim 16, further comprising following steps:
generating a fifth positioning data and a sixth positioning data according to a first predetermined weight, a second predetermined weight, the first positioning data and the second positioning data by an average calculating unit.

20. The positioning method as claimed in claim 19, wherein
the fifth positioning data is generated by the average calculating unit according to the following formula:
the fifth positioning data=the first predetermined weight*the first positioning data+the second predetermined weight*the second positioning data, wherein the first predetermined weight=(1−%Δz′), the second predetermined weight=%Δz′, and %Δz′≦0.5; or
the sixth positioning data is generated by the average calculating unit according to the following formula:
the sixth positioning data=the first predetermined weight*the first positioning data+the second predetermined weight*the second positioning data, wherein the first predetermined weight=%Δz′, the second predetermined weight=(1−%Δz′), and %Δz′≦0.5.
